(19) United States
(12) Patent Application Publication
(10) Pub. No.: US 2013/0250771 A1
(43) Pub. Date: Sep. 26, 2013

(54) DEVICE TO DEVICE ENHANCED VOICE GROUP CALL

(71) Applicants: Ling Yu, Oulu (FI); Vinh Van Phan, Oulu (FI); Kari Veikko Horneman, Oulu (FI)

(72) Inventors: Ling Yu, Oulu (FI); Vinh Van Phan, Oulu (FI); Kari Veikko Horneman, Oulu (FI)

(73) Assignee: Nokia Siemens Networks Oy, Espoo (FI)

(21) Appl. No.: 13/424,704

(22) Filed: Mar. 20, 2012

(51) Int. Cl. H04W 24/00

(52) U.S. Cl. 370/241

(57) ABSTRACT

Public safety networks, such as long term evolution (LTE) based public safety networks, can benefit from device to device enhanced voice group call. A method can include serving at least one user equipment. The method can also include controlling device-to-device cluster establishing for the at least one user equipment based on at least one reference signal. This use of device-to-cluster establishment based on at least one reference signal can be applied in various ways, including being applied to group calls.

### BACKGROUND

1. Field

Public safety networks, such as long term evolution (LTE) based public safety networks, can benefit from device to device enhanced voice group call.

2. Description of the Related Art

In order to use long term evolution (LTE) of the 3rd Generation Partnership Project (3GPP) for a mobile broadband public safety network (PSN), various functionalities may be useful or important. In general, in a PSN speed of connection in terms of set time, rate, and so on, as well as reliability and security may be important features, regardless of network coverage issues, resource scarceness, or any type of network failure. However, current LTE does not support advanced direct device to device (D2D) communication and mission critical voice group call, but only voice group call with a conference call type application.

### SUMMARY

According to certain embodiments, a method includes serving at least one user equipment. The method also includes controlling device-to-device cluster establishing for the at least one user equipment based on at least one reference signal.

In certain embodiments, a method includes initiating a group call including a user equipment. The method also includes monitoring a multicast downlink bearer for a signal related to the group call.

A method, in certain embodiments, includes determining that a group call is suitable for modification to include device-to-device communication. The method also includes instructing at least one access point to control establishment of device-to-device communication among participants in the group call.

An apparatus, according to certain embodiments, includes at least one processor and at least one memory including computer program code. The at least one memory and the computer program code are configured to, with the at least one processor, cause the apparatus at least to initiate a group call including a user equipment. The at least one memory and the computer program code are also configured to, with the at least one processor, cause the apparatus at least to monitor a multicast downlink bearer for a signal related to the group call.

According to certain embodiments, an apparatus includes at least one processor and at least one memory including computer program code. The at least one memory and the computer program code are configured to, with the at least one processor, cause the apparatus at least to serve at least one user equipment. The at least one memory and the computer program code are also configured to, with the at least one processor, cause the apparatus at least to control device-to-device cluster establishing for the at least one user equipment based on at least one reference signal.

An apparatus, according to certain embodiments, includes at least one processor and at least one memory including computer program code. The at least one memory and the computer program code are configured to, with the at least one processor, cause the apparatus at least to determine that a group call is suitable for modification to include device-to-device communication. The at least one memory and the computer program code are also configured to, with the at least one processor, cause the apparatus at least to instruct at least one access point to control establishment of device-to-device communication among participants in the group call.

An apparatus, in certain embodiments, includes initiating means for initiating a group call including a user equipment. The apparatus also includes monitoring means for monitoring a multicast downlink bearer for a signal related to the group call.

According to certain embodiments, an apparatus includes serving means for serving at least one user equipment. The apparatus also includes controlling means for controlling device-to-device cluster establishing for the at least one user equipment based on at least one reference signal.

In certain embodiments, an apparatus includes determining means for determining that a group call is suitable for modification to include device-to-device communication. The apparatus also includes instructing means for instructing at least one access point to control establishment of device-to-device communication among participants in the group call.

A non-transitory computer readable medium is, according to certain embodiments, encoded with instructions that, when executed in hardware, perform a process. The process includes initiating a group call including a user equipment. The process also includes monitoring a multicast downlink bearer for a signal related to the group call.

A non-transitory computer readable medium is, in certain embodiments, encoded with instructions that, when executed in hardware, perform a process. The process includes serving at least one user equipment. The process also includes controlling device-to-device cluster establishing for the at least one user equipment based on at least one reference signal.

According to certain embodiments, a non-transitory computer readable medium is encoded with instructions that, when executed in hardware, perform a process. The process includes determining that a group call is suitable for modification to include device-to-device communication. The process also includes instructing at least one access point to control establishment of device-to-device communication among participants in the group call.

### BRIEF DESCRIPTION OF THE DRAWINGS:

For proper understanding of the invention, reference should be made to the accompanying drawings, wherein:

FIG. 1 illustrates multicasting for group voice call according to certain embodiments.

FIG. 2 illustrates methods according to certain embodiments.

FIG. 3 illustrates a method according to certain embodiments.

FIG. 4 illustrates another method according to certain embodiments.

FIG. 5 illustrates a system according to certain embodiments.

### DETAILED DESCRIPTION:

Certain embodiment relate to advanced direct device to device (D2D) communication and mission critical voice group call, for example, for long term evolution (LTE). Thus, certain embodiments can help a public safety network (PSN) to be fast, reliable, and secure, despite lack of network coverage, lack of network resources, or any type of network failure. In certain embodiments, the group call users establish D2D clusters and only the D2D cluster head CH keeps an active uplink radio bearer (RB) towards the network for possible uplink voice stream transmission when one of the cluster members speaks. Thus, certain embodiments dynamically configure the UE for reference signal transmission and for monitoring the reference signal to setup the cluster based on involvement of the group call.

In general, a voice group call can be supported over an LTE network with a conference call, or similar, application. However, for each member of the conference call, an individual evolved packet system (EPS) bearer including a separate S1 bearer in the evolved packet core (EPC) and radio bearer (RB) over the air interface would be established to transmit each copy of the same voice stream to each user, because conventional LTE does not support multicast service for voice call. The S1 bearer is the bearer that transports the packets of an evolved universal terrestrial radio access network (E-UTRAN) radio access bearer (E-RAB) between an eNodeB and a serving gateway (GW). Simultaneous unicast of the group voice call to a number of group users in one cell can load the cell heavily, and the load is related to the number of group users. The situation can be aggravated when multiple group calls needs to be supported in a single cell simultaneously.

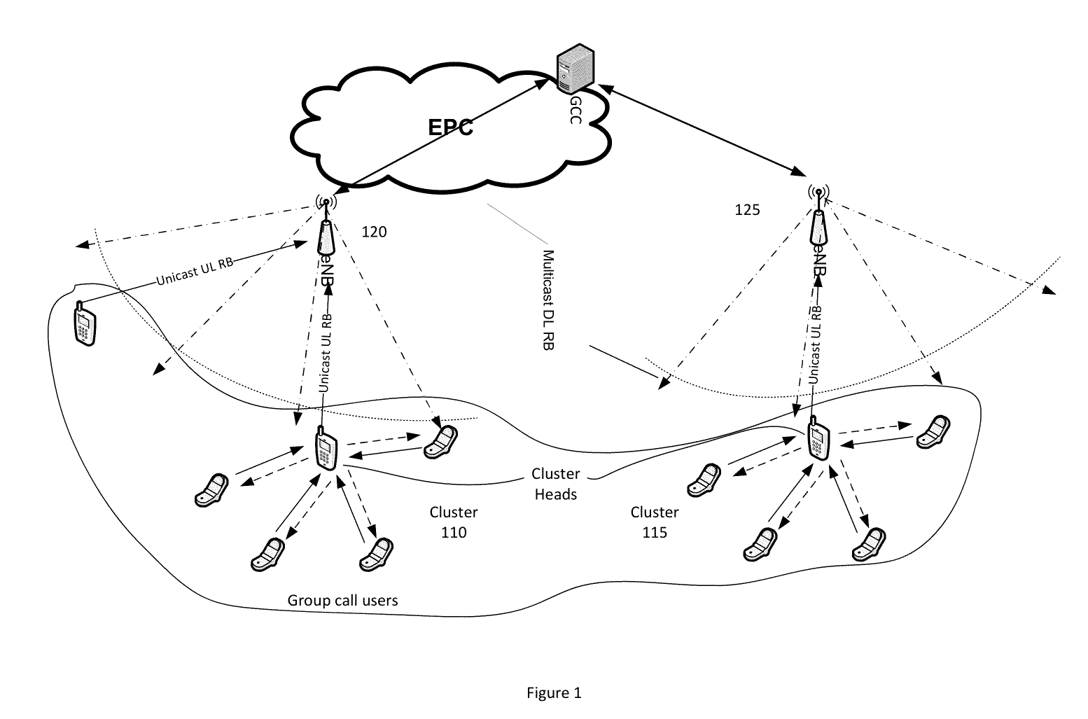

Accordingly, in certain embodiments, a multicasting function for supporting voice group is introduced into an LTE system, as shown in FIG. 1, to provide support for PSN requirements. With a multicasting function in downlink (DL) for supporting voice group call in LTE system, a separate uplink (UL) evolved packet system (EPS) bearer can still be used for each user of the group call in order to allow the user of the group freely speaks to the whole group. Having an active EPS bearer for each user in uplink with bursty transmission for speaking occasions may not consume extra radio resources in the LTE system. However, keeping the active uplink EPS bearer still can consume a minimum signaling exchange between each user device and the network. Also, a dedicated downlink (DL) radio bearer (RB) may be setup. For example, in order to keep uplink synchronization, timing advance information can be transmitted to a user device from the eNB. Therefore, having a dedicated uplink bearer established for each user of the group call may be resource intensive.

In an example use case of a group call in a public safety network, the users may be, for example, the law enforcement, public safety, or search and rescue officers on the site of the incident, such as an accident, fire, or crime. In these cases, the users of the voice group call may be located near to each other and can be reached by device to device (D2D) communication.

Accordingly, D2D communication can be incorporated with group call functions. One effect of such incorporation may be to reduce the impact of the group call on local network resources. A D2D enhanced group call for an LTE-based PSN is illustrated FIG. 1, in which the group call users establish D2D clusters (110 and 115) and only the D2D cluster head of each cluster keeps an active uplink RB toward the network. The D2D cluster head can keep this active for possible uplink voice stream transmission when one of the cluster members speaks.

Certain embodiments more specifically provide a control and transmission mechanism for a D2D enhanced voice group call in an LTE system, which can serve and support a PSN.

Network controlled D2D cluster establishment for an ongoing group call is one option. After a group call is initiated, each UE can have a dedicated uplink bearer established for the group call service and can start monitoring the multicast DL bearer(s). There may be separate control and data multicast bearers established. Then, a group call center (GCC) and mobility management entity (MME) can identify the eNodeBs (eNBs) that are serving the local group call users and can request the serving eNB(s) to control the D2D cluster establishment for the ongoing group call. Control plane (C-plane) S1AP IDs unique to active UEs can be used by the mobility management entity (MME) to identify the UEs of the on-going group call with the serving eNB.

Each serving eNB(s) can select certain UE(s) to act as the D2D cluster head(s). The selection can be based on the UE's capability, battery status, active radio bearers (RBs) status, radio channel condition, geographical location, user priority, subscription profile, and so forth.

Using the multicast DL RB, the eNB(s) can configure the selected UEs to broadcast certain reference signals for D2D discovery and at the same time inform the other UEs of the group call about the reference signals that the selected D2D cluster heads will broadcast. If multiple UEs have been selected as D2D cluster heads in one cell, the reference signals assigned to the selected UEs can be configured with different priority and transmission power. The configuration information may be either transmitted via Medium Access Control (MAC) control-type protocol data unit (C-PDU) on multicast DL data RB or as the radio resource control (RRC) control signaling on multicast DL control RB if separate multicast control RB is defined. As no feedback may be expected for multicast transmission, the same transmission of the control information may be repeated in order to achieve higher signaling reliability. In addition, if more than one neighboring eNB is involved in serving the group call then these eNB(s) may interact and exchange information related to the group call over X2, including D2D cluster head selection and configuration.

For example, referring to FIG. 1, eNB 120 can be configured to communicate with eNB 125 over X2, in case it is possible to have a cluster that spans more than one cell, in view of the UE capabilities. This may be particularly the case when the cluster exists near the coverage boundaries between eNB120 and eNB 125.

The UEs of the group call can then start scanning the reference signals in the order of the configured priority. The UEs can join the D2D cluster as soon as the first D2D cluster head is found. After a certain time period, the standalone D2D cluster head can join another D2D cluster if it can discover the other D2D cluster head. The time can be defined by a timer that is configured by the network. This re-selection to a new D2D cluster can occur specifically when no other UE has joined the original D2D cluster, and thus the D2D cluster head is standalone.

The UE, upon joining a D2D cluster, can keep an active D2D link toward the D2D cluster head and can have the dedicated uplink bearer for the group call released or at least virtually released. In a virtual release, some bearer contexts are kept for fast mode switching or user information mapping but no actual transmissions are carried on. The UE may even be allowed to go into radio resource control (RRC) idle or longest discontinuous reception (DRX) dormant state of the group call if no RB is activated for other services. The longest DRX dormant state may not be exactly the same as RRC idle state of a regular user as discussed below, in order to have some reserved radio network temporary identifier (RNTI) assigned.

Another aspect of certain embodiments relates to the indication of a speaking UE's identifier in multicast transmission of group call voice stream by the eNB. Either in RRC idle or active state, the UEs of the group call can use the multicast DL RB for reception of the group call voice stream. The speaking UE in the group call can also listen to the multicast DL RB. Thus, the speaking UE's identifier may be indicated on the L1-L2 radio layer to allow the speaking UE to avoid decoding the voice stream of itself Alternatively, if local recording is used, the speaking UE can decode the voice stream of itself for recording purposes. The multicast DL RB may, for example, be sent on the downlink shared channel (DL-SCH). Therefore, the physical downlink control channel (PDCCH) based dynamic scheduling can be applicable to the multicast DL RB. The following alternatives can be used for indicating the speaking UE's identifier on L1-L2 radio layer.

For example, in a certain embodiment, the scheduling information on PDCCH for the multicast DL RB is addressed to the group call specific RNTI and the speaking UE's identifier is included in the downlink control information (DCI) transmitted on PDCCH addressed by the group call RNTI. For this purpose, a new type of DCI may be defined. Otherwise, for another example, the speaking UE's identifier can be included in media access control (MAC) control packet data unit (PDU) multiplexed with the MAC service data unit (SDU) of the multicast DL RB. For the latter case, the speaking UE can decode the data transmitted on the multicast DL RB and ignore the received MAC SDU if the MAC control PDU indicates the UE identifier of itself.

As another alternative, the serving eNB can reserve a group or range of RNTIs for the group call. Each UE that joins the group call via the eNB can be assigned one of the reserved RNTIs, regardless of whether the UE is in idle or active state. UEs in RRC active state may have another C-RNTI for other services. Thus, the RNTI for the group call itself can be different from the C-RNTI. The scheduling information on the physical downlink control channel (PDCCH) for the multicast DL RB of the group call can be addressed to the speaking UE's RNTI. The UEs of the group call can detect the PDCCH for multicast DL RB reception with the group or range of the RNTIs reserved for the group call. If the UEs detect the PDCCH masked with one of the reserved RNTIs, they follow the DCI transmitted on PDCCH to receive the multicast DL RB of the group call. However, the speaking UE can ignore the information transmitted on PDCCH upon detecting the PDCCH masked with its own RNTI, and hence does not have to receive the multicast DL RB, although the speaking UE can receive and decode the multicast DL RB if desired, such as for local recording or to detect spoofing.

According to another aspect, in certain embodiments group call voice stream is mediated by the D2D cluster head from the speaking UE, as a D2D cluster member, to the eNB via the D2D link and the active uplink RB that is established for the D2D cluster head. Because the same uplink RB is used for transmission of group call voice stream for all the cluster members, the speaking UE's identifier can be indicated to the eNB by the cluster head in order to allow the indication of the speaking UE's identifier in the multicast DL transmission. When the user of the cluster head is speaking, the cluster head's identifier can be indicated to the eNB, or alternatively the indication can be omitted. In embodiments where more than one UE is permitted to speak simultaneously, the cluster head can combine the streams before sending them to the eNB, or alternatively, can maintain the streams separate (by, for example, using corresponding multiplexing options on physical layer or above layer).

Certain embodiments, therefore, relate to network controlled D2D cluster establishment for an ongoing group call. Certain embodiments provide for how to use the cluster and the cluster head (CH) in realizing a group call instead of using a conference call for creating a group call. In particular, certain embodiments consider the assignment of reference signals that are transmitted and monitored by UEs. According to certain embodiments, the cluster head can be selected by the base station, and the configuration of reference signal can be dynamic. For example, the configuration can be done by the base station on-the-fly and the configuration can be based on the established group call, that is, for example, having or using a DL multicast RB. The UEs that are involved in the group call can be notified about the reference signals broadcasted by the cluster head, in order for the UEs to detect the correct cluster head to join the cluster. The formation of the cluster can be based on the involvement of the group call and the established DL multicast RB thereof, so that only UEs that are participating in the group call can be notified of the reference signal, and then be able to detect the cluster head in order to join the cluster.

According to certain embodiments, the network can include a specific network element, such as a group call controller (GCC), that controls the group call establishment. According to certain embodiments, each cluster head can maintain unicast uplink communications (for example, using dedicated UL RB) to the eNB in which coverage area the cluster head resides. Also, individual UEs belonging to the group call but not belonging to any cluster, for example, not operating in D2D mode with other group members, can be connected with unicast uplink communications to the eNB. There may also be some alone or spatially separated UE which belongs to the group call but can better be served with unicast or dedicated connection for both UL and DL.

The eNB can multicast the downlink communication from eNB both to all cluster heads having one or more UEs in their cluster, communicating in D2D, and to the individual UEs outside of any cluster but belonging to the group call. Indeed, the DL multicast from eNB can be multicast directly to all UEs inside or outside of any clusters but belonging to the group call. In the case of only for a few CHs and some spatially separated UEs then using unicast to the separated UEs and the CHs may be employed instead of multicast. If a group member UE is outside the coverage of the eNB or if the unicast approach is used, the cluster head can multicast or unicast downlink the group call voice signal to the group member UEs. The cluster member UEs that belong to the group can unicast uplink/downlink, using, for example, D2D uplink/downlink, bearer communication to the cluster head and optionally to other group member UEs that belong to the same cluster.

Alternatively the cluster member UEs that belong to the group can multicast their uplink communication to other group members, which is more D2D than uplink communication, and to the cluster Head. The cluster head can relay the communication from the cluster UEs in uplink unicast communication to the eNB, which may multicast the communication to other clusters and to individual group member UEs. Alternatively, the cluster head can multi-cast the communication to the other group members, in addition to relaying the communication to the eNB.

As noted above, using the multicast DL radio bearer, the eNB(s) can configure the selected UEs, for example, the cluster heads, to broadcast certain reference signals for D2D discovery and at the same time the eNB can inform the other UEs of the group call and of the reference signals that the selected D2D cluster heads will broadcast, so that the UEs can discover and join any cluster in the group.

Accordingly, certain embodiments can effectively establish group call using partially D2D clusters and a group call center and using broadcasted reference signals. This can be done by multicasting all downlink group call messages from the eNB or from the cluster heads.

In certain embodiments, the cluster head user equipment may be a special, high-powered user equipment, such as a user equipment that is attached to, mounted on, and/or draws power from a vehicle.

With certain embodiments, a full-duplex voice group call can be supported in LTE system in an efficient way. For downlink multicast transmission, the optional control RB may be only used for clear control plane and user plane separation. If multicast control RB is defined, a speaking UE's identifier may also be indicated by the control RB.

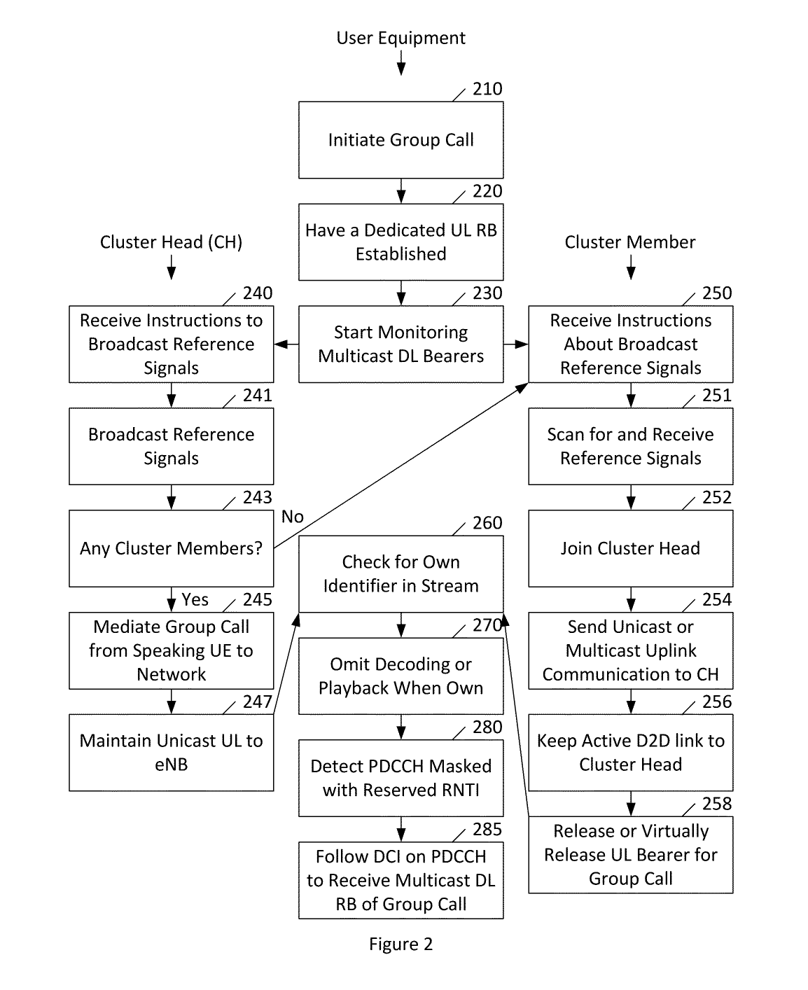

FIG. 2 illustrates methods according to certain embodiments. The methods shown can be performed by user equipment, including user equipment that are configured to serve as a cluster head (CH) or a cluster member. As shown in FIG. 2, at 210 a group call can be initiated. The group call can be initiated by the user equipment as a caller or as a called party in the initial set up. At 220, the user equipment can have a dedicated uplink (UL) radio bearer (RB) established for the on-going group call. Subsequently, at 230, the user equipment can be monitoring for multicast DL bearers.

A user equipment that is to be a cluster member can receive instructions about broadcast reference signals, at 250. The user equipment can than scan for and receive reference signals at 251. At 252, the user equipment can join a cluster head and become a cluster member of that cluster. The cluster to be joined can be selected based on which cluster head is detected by the user equipment first. The communications between the cluster member and the cluster head can be device-to-device communications.

At 254, when the user equipment has communication to send to the group call, the user equipment can unicast the communication to the cluster head, or can multicast the communication to all the members of the cluster. In another alternative, the user equipment can unicast the communication to another member of the cluster than the cluster head, and the other member of the cluster can relay the communication to the cluster head.

The cluster member can keep an active device-to-device (D2D) communication link to the cluster head, at 256. However, at 258, the cluster member can release or virtually release the uplink bearer that was previously being used for the group call.

In the case of a user equipment that is to be a cluster head, the user equipment can, at 240, receive instructions to broadcast reference signals. Thus, at 241, the user equipment can broadcast reference signals, in the role of cluster head. After some predetermined amount of time, the cluster head can determined whether a cluster has formed, that is, at 243, the user equipment can determine whether there are any cluster members in the cluster. If not, then the user equipment can take on the role of cluster member to another cluster head.

If there is at least one cluster member, however, at 245 the cluster head can mediate group call communication to a network from a user equipment that is communicating. Such a user equipment can be referred to as a speaking user equipment (UE), but it is not necessary that the communication be voice communication. Other kinds of communication including multimedia communication, video, and text communication are also permitted. At 247, the cluster head can maintain a unicast uplink to a serving eNodeB (eNB).

At 260, a user equipment in the group call can monitor the multicast downlink communications, or stream, for the UE's own identifier, at 260. Then, at 270, the user equipment can omit decoding or playback of the group call when the user equipment determines that the UE's own communication is being provided.

The user equipment can detect a physical downlink control channel masked with a reserved RNTI, such an RNTI from a reserved range in which the UE's own RNTI is found, at 280. Then, at 285, the user equipment can follow the DCI on the PDCCH to receive the multicast DL radio bearer (RB) of the group call.

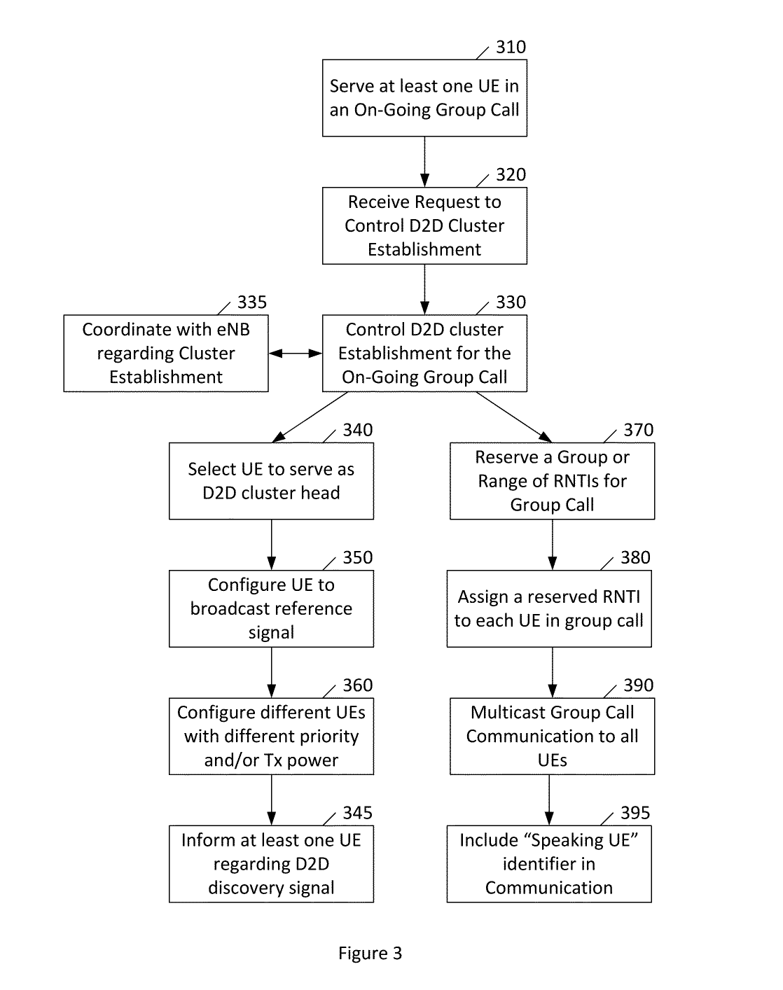

FIG. 3 illustrates a method according to certain embodiments. The method of FIG. 3 may be performed by an access point or base station, such an eNode B (eNB). As shown in FIG. 3, the method can include, at 310, serving at least one user equipment (UE) in an on-going group call. The method can also include, at 320, receiving a request to control device-to-device cluster establishment with respect to the group call. This request can come from a group call center.

In response to the request, at 330, the method can include controlling D2D cluster establishment for the on-going group call. In performing this control, the eNB can coordinate with another eNB regarding cluster establishment, at 335. For example, the two eNBs may be in the same geographic area, and thus the potential cluster may be across the coverage boundary of the two eNBs. Coordination amongst multiple access points is also possible.

At 340, the eNB can select a user equipment, or more than one, to serve as a D2D cluster head. Then, at 350, the eNB can configure the selected user equipment to broadcast a reference signal for D2D discovery. At 360, the eNB can configured different UEs to broadcast reference signals with different priority and/or with different transmission power. These actions can be particularly taken toward prospective cluster head user equipment. With respect to prospective cluster member user equipment, the eNB can inform at least one user equipment, at 345, regarding a D2D discovery signal, so that the user equipment can scan for such a signal.

At 370, the eNB can reserve a group or range of RNTIs for user equipment for the group call. Then, at 380, the eNB can assign a reserved RNTI to each UE in the group call.

At 390, the eNB can multicast a group call communication to all the UEs of the group call, which the eNB serves. There may be UEs of the group call that the eNB does not serve. Meanwhile, at 395, the eNB can include in the multicast communication, an indication of the “speaking UE,” namely the UE that is the source of the communication. This indication can also be referred to as a source identifier.

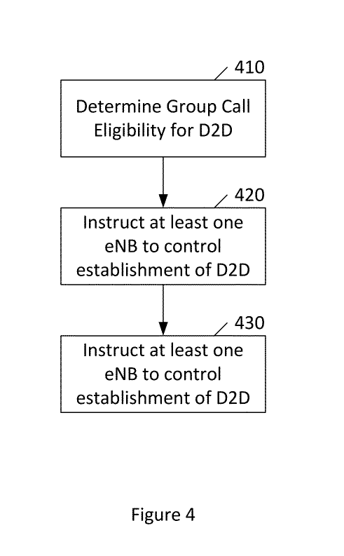

FIG. 4 illustrates another method according to certain embodiments. The method of FIG. 4 may be performed by, for example, a group call center (GCC). As shown in FIG. 4, the GCC can, at 410, make a determination regarding the eligibility of a call for enhancement or optimization by the use of device-to-device cluster communication. This determination can be based on identifying that a large number of devices in a small geographic area, or within the coverage area of a particular eNB, are communicating with one another using a group call. Alternatively, the determination can be made by upon determining that a public safety network (PSN) has been put into active use for an emergency. Other criteria for determining that D2D communication is appropriate or applicable can also be used.

At 420, the GCC can identify the relevant eNB(s) that are serving participants in the group call. Then, at 430, the GCC can instruct at least one access point, such as an eNB, to control establishment of D2D communication with respect to the group call, such that at least some of the participants can form a cluster.

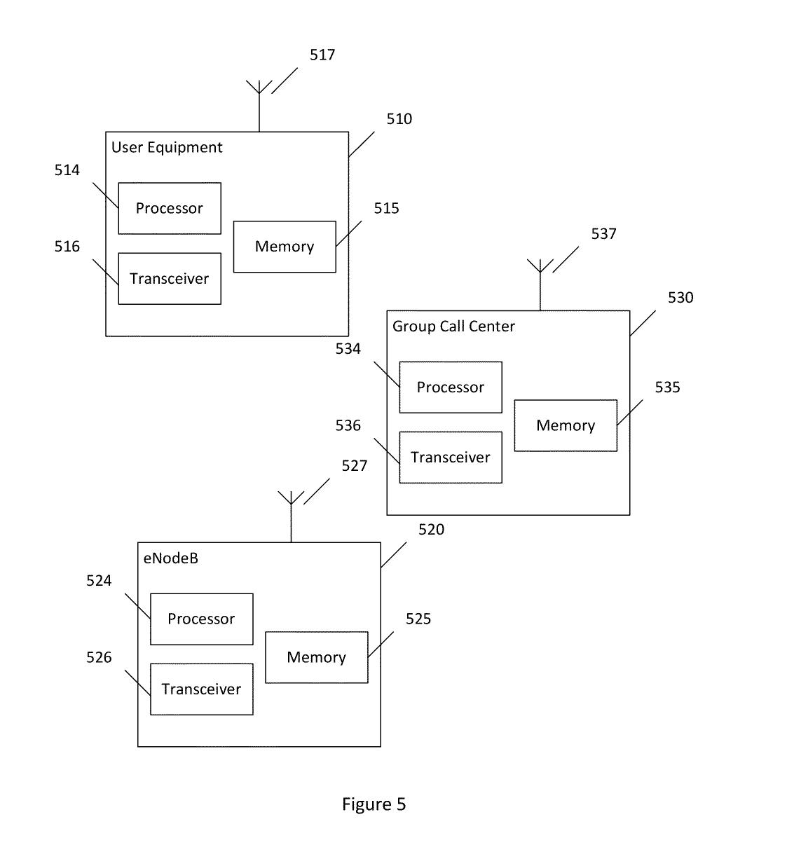

FIG. 5 illustrates a system according to certain embodiments. In an example embodiment, a system may include multiple devices, such as one more user equipment (UE) 510, eNodeB 520, and group call center 530. Each of the devices 510, 520, and 530 may be equipped with at least one processor (respectively 514, 524, and 534), at least one memory (respectively 515, 525, and 535) (including computer program instructions or code), a transceiver (respectively 516, 526, and 536), and an antenna (respectively 517, 527, and 537). There is no requirement that each of these devices be so equipped. For example, the eNodeB 520 may be equipped for wired communication with a core network (not shown), and the group call center 530 may be exclusively configured for wired communication and may be located in, or at the edge of, the core network. Moreover, the devices may have multiple radios and antenna not shown.

The transceiver (respectively 516, 526, and 536) can be a transmitter, a receiver, both a transmitter and a receiver, or a unit that is configured both for transmission and reception. The transceiver (respectively 516, 526, and 536) can be coupled to corresponding one or more antenna(s) (respectively 517, 527, and 537), which may include a directional antenna.

The at least one processor (respectively 514, 524, and 534) can be variously embodied by any computational or data processing device, such as a central processing unit (CPU) or application specific integrated circuit (ASIC). The at least one processor (respectively 514, 524, and 534) can be implemented as one or a plurality of controllers.

The at least one memory (respectively 515, 525, and 535) can be any suitable storage device, such as a non-transitory computer-readable medium. For example, a hard disk drive (HDD) or random access memory (RAM) can be used in the at least one memory (respectively 515, 525, and 535). The at least one memory (respectively 515, 525, and 535) can be on a same chip as the corresponding at least one processor (respectively 514, 524, and 534), or may be separate from the corresponding at least one processor (respectively 514, 524, and 534).

The computer program instructions may be any suitable form of computer program code. For example, the computer program instructions may be a compiled or interpreted computer program.

The at least one memory (respectively 515, 525, and 535) and computer program instructions can be configured to, with the at least one processor (respectively 514, 524, and 534), cause a hardware apparatus (for example, user equipment 510, eNodeB 520, or group call center 530) to perform a process, such as any of the processes described herein (see, for example, FIGS. 1-4).

Thus, in certain embodiments, a non-transitory computer-readable medium can be encoded with computer instructions that, when executed in hardware perform a process, such as one of the processes described herein. Alternatively, certain embodiments may be performed entirely in hardware.

The devices of the system may also include additional components. For example, each of user equipment 510, eNodeB 520, and group call center 530 can include a user interface that is operable connected to the processor (respectively 514, 524, and 534) and memory (respectively 515, 525, and 535). That user interface can include a display, such as a liquid crystal display (LCD) or organic electroluminescent display (OELD), as well as speakers or audio outputs. Tactile outputs, such as a haptic feedback system, can also be included. The user interface may have a touch screen to receive user input. User input can also be provided by a keypad, keyboard, microphone, joystick, mouse, trackball, or other input device. Of course, there is no requirement that the devices include a user interface. For example, the eNodeB 520 and group call center 530 may be embodied in part as one or more rack-mounted computers.

The devices of the system can also include peripheral devices that are connected wirelessly by, for example, a short-range wireless connection. Thus the devices of the system can be configured with more than one radio system, and can be configured for operation in more than one mode.

Although FIG. 5 illustrates a system including an eNodeB, a user equipment, and a GCC, certain embodiments may be applicable to other configurations. For example, in certain embodiments, another kind of access point or base station could be supplied instead of the eNodeB.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

We claim:

1. A method, comprising:
initiating a group call including a user equipment; and
monitoring a multicast downlink bearer for a signal related to the group call, wherein the signal is related to setting up a device-to-device cluster for the group call with respect to a reference signal.

2. The method of claim 1, further comprising:
device-to-device communicating within a cluster of user equipment participating in the group call, wherein the cluster includes the user equipment.

3. The method of claim 1, further comprising:
determining whether the signal includes the user equipment's own identifier; and
omitting decoding or playback of communication on the signal when the signal includes the user equipment's own identifier.

4. The method of claim 1, further comprising:
broadcasting the reference signal, wherein the reference signal indicates that the user equipment is a cluster head.

5. The method of claim 4, further comprising:
determining, after a predetermined period from the reference signal, whether any cluster members have been associated with the user equipment, and, if not, discontinuing serving as the cluster head.

6. The method of claim 1, further comprising:
mediating a group call communication from a cluster member to a communication network.

7. The method of claim 1, further comprising:
maintaining a unicast uplink to a communication network for the group call, after beginning device to device communication regarding the group call.

8. The method of claim 1, further comprising:
scanning for a broadcast signal for a cluster head related to the group call.

9. The method of claim 1, further comprising:
joining a cluster head for the group call as a cluster member.

10. The method of claim 9, further comprising:
keeping an active device to device link to the cluster head after joining the cluster head.

11. The method of claim 9, further comprising:
releasing or virtually releasing an uplink bearer for the group call, after joining the cluster head, while maintaining the group call.

12. The method of claim 1, further comprising:
sending communication to the group call by unicast or multicast communication with a cluster head.

13. A method, comprising:
serving at least one user equipment, wherein the serving comprises setting up a downlink multicast bearer for a group call; and
controlling device-to-device cluster establishing for the at least one user equipment based on at least one reference signal.

14. The method of claim 13, wherein the controlling the cluster establishment comprises selecting at least one user equipment to serve as a cluster head.

15. The method of claim 13, wherein the controlling the cluster establishment comprises configuring a user equipment to broadcast a reference signal.

16. The method of claim 13, wherein the controlling the cluster establishment comprises controlling different user equipment to broadcast references signals having different priority and/or transmission power from one another.

17. The method of claim 13, wherein the controlling the cluster establishment comprises instructing at least one user equipment to scan for a device-to-device discovery signal.

18. The method of claim 13, further comprising:
multicasting a downlink bearer for a signal related to the group call.

19. The method of claim 18, wherein the multicasting the downlink bearer comprises including a source identifier with the downlink bearer for communications related to the group call.

20. A method, comprising:
determining that a group call is suitable for modification to include device-to-device communication; and
instructing at least one access point to control establishment of device-to-device communication among participants in the group call, wherein the establishment includes setting up at least one device-to-device cluster based on a reference signal and wherein the group call is set up for multicast downlink communication.

21. An apparatus, comprising:
at least one processor; and
at least one memory including computer program code,
wherein the at least one memory and the computer program code are configured to, with the at least one processor, cause the apparatus at least to
initiate a group call including a user equipment; and
monitor a multicast downlink bearer for a signal related to the group call, wherein the signal is related to setting up a device-to-device cluster for the group call.

22. An apparatus, comprising:
at least one processor; and
at least one memory including computer program code,
wherein the at least one memory and the computer program code are configured to, with the at least one processor, cause the apparatus at least to
serve at least one user equipment, comprising setting up a downlink multicast bearer for a group call; and
control device-to-device cluster establishing for the at least one user equipment based on at least one reference signal.

23. An apparatus, comprising:
at least one processor; and
at least one memory including computer program code,
wherein the at least one memory and the computer program code are configured to, with the at least one processor, cause the apparatus at least to
determine that a group call is suitable for modification to include device-to-device communication; and
instruct at least one access point to control establishment of device-to-device communication among participants in the group call, wherein the establishment includes setting up at least one device-to-device cluster based on a reference signal and wherein the group call is set up for multicast downlink communication.
